(19) United States
(12) Patent Application Publication
(10) Pub. No.: US 2024/0427558 A1
(43) Pub. Date: Dec. 26, 2024

(54) GRAPHIC DESIGN CODE GENERATION PLUGIN SYSTEM

(71) Applicant: Figma, Inc., San Francisco, CA (US)

(72) Inventors: Sawyer Hood, San Francisco, CA (US); Rohit Chouhan, San Francisco, CA (US); Elizbeth Avery Frankenberg, San Francisco, CA (US); Yi Tang Jackie Chui, San Francisco, CA (US); Michael Yong, San Francisco, CA (US); Bersabel Tadesse, San Francisco, CA (US)

(21) Appl. No.: 18/748,965

(22) Filed: Jun. 20, 2024

Related U.S. Application Data
(60) Provisional application No. 63/522,049, filed on Jun. 20, 2023.

(51) Int. Cl. G06F 8/20; G06F 8/34

(52) U.S. Cl. CPC G06F 8/20; G06F 8/34

(57) ABSTRACT

A graphic design implementation system provides a design interface to render at least a portion of a graphic design and a code interface to render a code representation for at least a portion of the graphic design. Providing the code interface includes executing one or more plugins to generate the code representation, the one or more plugins including at least a first plugin that is selectable by a user to configure the generation of the code representation in accordance with one or more preferences.

### RELATED APPLICATIONS

This application claims benefit of priority to Provisional U.S. Patent Application No. 63/522,049, filed Jun. 20, 2023; the aforementioned priority application being hereby incorporated by reference in its entirety.

### TECHNICAL FIELD

Examples described herein relate to a system for implementing graphic designs for an executable production environment.

### BACKGROUND

Software design tools have many forms and applications. In the realm of application user interfaces, for example, software design tools require designers to blend functional aspects of a program with aesthetics and even legal requirements, resulting in a collection of pages which form the user interface of an application. For a given application, designers often have many objectives and requirements that are difficult to track.

### BRIEF DESCRIPTION OF THE DRAWINGS

FIG. 1 illustrates a graphic design implementation system, according to one or more examples.

FIG. 2 illustrates a method of using a graphic design code generation plugin system, according to one or more examples.

FIG. 3 illustrates an example developer mode plugin interface.

FIG. 4 illustrates an example use of a developer plugin generating a portion of a graphic design.

FIG. 5 illustrates a computer system on which one or more embodiments can be implemented.

FIG. 6 illustrates a user computing device for use with one or more examples, as described.

### DETAILED DESCRIPTION

In examples, a computing system is configured to implement a graphic design implementation system (GDIS) or platform for enabling users to create various types of content, including graphic designs, whiteboards, presentations, web pages, etc. Among other advantages, examples as described enable such users to utilize plugins to extend or supplement the functionality of a graphic design implementation system for their particular needs, such as generating code representations of their graphic designs in a selected programming language.

Furthermore, the information developers need to correctly implement a design in a production environment can reside in many different places: product requirements, design systems documentation, understanding of which aspects of a design already exist in a codebase—each can be stored in different tools. Developer plugins for a GDIS can integrate with these other tools and enable developers to pull in relevant information required to implement a design, all in one place.

Code generation is an important part of the handoff from graphic designer to developer, but there is a proliferation of frontend programming languages, dozens of popular frontend frameworks, and different conventions for how each one is used within a company or team. In contrast to conventional approaches, a developer plugin system enables developers to generate code for any frontend language, framework, or convention they want. Code generation plugins extend and replace the built-in code generation provided to users of the GDIS and can be used to generate code for languages or frameworks that the GDIS does not support natively or for surfacing other metadata that a user might want (e.g., where to import icons in code or internationalization string extraction).

In embodiments, a graphic design implementation system provides a design interface to render at least a portion of a graphic design and a code interface to render a code representation for at least a portion of the graphic design. Providing the code interface includes executing one or more plugins to generate the code representation, the one or more plugins including at least a first plugin that is selectable by a user to configure the generation of the code representation in accordance with one or more preferences.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, a software component, or a hardware component capable of performing one or more stated tasks or functions. As used herein, a module or component can exist on a hardware component independently of other modules or components. Alternatively, a module or component can be a shared element or process of other modules, programs, or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more aspects described herein may be implemented through the use of instructions that are executable by one or more processors. These instructions may be stored on a computer-readable medium. Machines shown or described with figures below provide examples of processing resources and computer-readable media on which instructions for implementing some aspects can be stored and/or executed. In particular, the numerous machines shown or described include processors and various forms of memory for storing data and instructions. Examples of computer-readable media include permanent memory storage devices, such as hard disk drives on personal computers or servers. Other examples of computer storage media include portable storage units, such as CD or DVD units, flash or solid-state memory (such as carried on cell phones, tablets, and other consumer electronic devices), and magnetic memory. Computers, terminals, and network-enabled devices (e.g., mobile devices such as cell phones) are all examples of machines and devices that utilize processors, memory, and instructions stored on computer-readable media.

Alternatively, one or more examples described herein may be implemented through the use of dedicated hardware logic circuits that are comprised of an interconnection of logic gates. Such circuits are typically designed using a hardware description language (HDL), such as Verilog and VHDL. These languages contain instructions that ultimately define the layout of the circuit. However, once the circuit is fabricated, there are no instructions, and processing is performed by interconnected gates.

### System Description

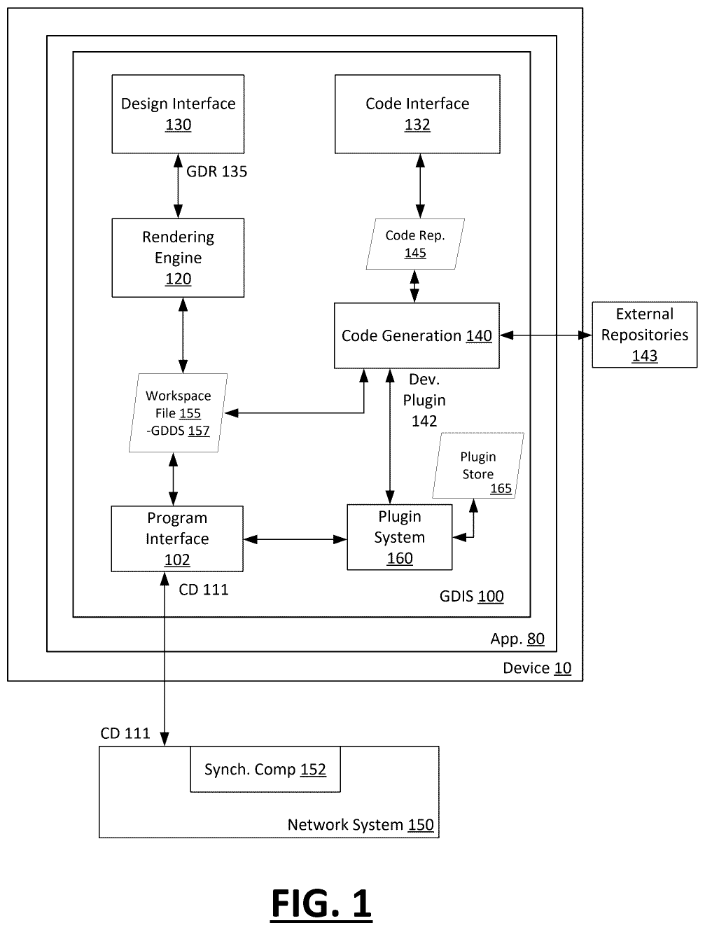

FIG. 1 illustrates a graphic design implementation system, according to one or more examples. A graphic design implementation system 100 (“GDIS 100”) as described with FIG. 1 can be implemented in any one of multiple different computing environments, including as a device-side application, as a network service, and/or as a collaborative platform. In examples, the GDIS 100 can be implemented using a web-based application 80 that executes on a user device 10. In other examples, the GDIS 100 can be implemented through use of a dedicated web-based application. As an addition or alternative, one or more components of the GDIS 100 can be implemented as distributed system, such that processes described with various examples execute on both a network computer (e.g., server) and on the user device 10.

In examples, the GDIS 100 includes processes that execute through a web-based application 80 that is installed on the computing device 10. The web-based application 80 can execute scripts, code and/or other logic to implement functionality of the GDIS 100. Additionally, in some variations, the GDIS 100 can be implemented as part of a network service, where web-based application 80 communicates with one or more remote computers (e.g., server used for a network service) to executes processes of the GDIS 100.

In examples, a user device 10 includes a web-based application 80 that loads processes and data for providing the GDIS 100 on a user device 10. The GDIS 100 can include a design interface 130 that enables users to create, edit, and update graphic design files as well as a rendering engine 120 to read the graphic design files and display them on the design interface 130.

In some examples, the web-based application 80 retrieves programmatic resources for implementing the GDIS 100 from a network site. As an addition or alternative, web-based application 80 can retrieve some or all of the programmatic resources from a local source (e.g., local memory residing with the computing device 10). The web-based application 80 may also access various types of data sets in providing functionality such as described with the GDIS 100. The data sets can correspond to files and libraries, which can be stored remotely (e.g., on a server, in association with an account) or locally.

According to examples, the user of a user device 10 operates web-based application 80 to access a network site, where programmatic resources are retrieved and executed to implement the GDIS 100. The user can initiate a session to implement the GDIS 100 to view, create, and edit a graphic design, as well as to generate program code for implementing the graphic design in a production environment. In some examples, the user can correspond to a designer who creates, edits, and refines the graphic design for subsequent use in a production environment. The other examples, the user can correspond to a developer who accesses the graphic design in order to retrieve assets and program code corresponding to the graphic design for subsequent use in a production environment.

In examples, the web-based application 80 can correspond to a commercially available browser, such as GOOGLE CHROME (developed by GOOGLE, INC.), SAFARI (developed by APPLE, INC.), EDGE (developed by the MICROSOFT CORPORATION), etc. In such examples, the processes of the GDIS 100 can be implemented as scripts and/or other embedded code which the web-based application 80 downloads from a network site. For example, the web-based application 80 can execute code that is embedded within a webpage to implement processes of the GDIS 100. The web-based application 80 can also execute the scripts to retrieve other scripts and programmatic resources (e.g., libraries) from the network site and/or other local or remote locations. By way of example, the web-based application 80 may execute JAVASCRIPT embedded in an HTML resource (e.g., webpage structured in accordance with HTML 5.0 or other versions, as provided under standards published by W3C or WHATWG consortiums). In other variations, the GDIS 80 can be implemented through use of a dedicated application, such as a web-based application.

The GDIS 100 can include processes represented by a programmatic interface 102, rendering engine 120, design interface 130, code interface 132, and code generation 140. Depending on implementation, the components can execute on the user device 10, on a network system (e.g., server or combination of servers), or on the user device 10 and a network system (e.g., as a distributed process).

The programmatic interface 102 includes processes to receive and send data for implementing components of the GDIS 100. Additionally, the programmatic interface 102 can be used to retrieve, from local or remote sources, programmatic resources and data sets which include a workspace file 155 associated with the user or user's account. In examples, the workspace file 155 includes one or more data sets (represented by graphic design data set 157) that represent a corresponding graphic design that can be rendered by the rendering engine 120. The workspace file 155 can include one or more graphic design data sets 157 which collectively define a design interface. The graphic design data set 157 can be structured as one or more hierarchical data structures. In some examples, the graphic design data set 157 can be structured to define a graphic design as a collection of layers, where each layer corresponds to an object, group of objects, or specific type of object. Further, in some examples, the graphic design data set 157 can be organized to include graphic designs on screens, where each graphic design including one or more pages (e.g., with one canvas per page), or sections that include one or multiple pages.

According to an aspect, the programmatic interface 102 also retrieves programmatic resources that include an application framework for implementing the design interface 130. The design interface 130 can utilize a combination of local, browser-based resources and/or network resources (e.g., an application framework) provided through the programmatic interface 102 to generate interactive features and tools that can be integrated with a rendering of the graphic design on a canvas. The application framework can enable a user to view and edit aspects of the graphic designs. In this way, the design interface 130 can be implemented as a functional layer that is integrated with a canvas on which the graphic design is provided.

The design interface 130 can detect and interpret user input, based on, for example, the location of the input and/or the type of input. The location of the input can reference a canvas or screen location, such as for a tap, or start and/or end location of a continuous input. The types of input can correspond to, for example, one or more types of input that occur with respect to a canvas, or design elements that are rendered on a canvas. Such inputs can correlate to a canvas location or screen location, to select and manipulate design elements or portions thereof. Based on canvas or screen location, a user input can also be interpreted as input to select a design tool, such as may be provided through the application framework. In implementation, the design interface 130 can use a reference of a corresponding canvas to identify a screen location of a user input (e.g., ‘click’). Further, the design interface 130 can interpret an input action of the user based on the location of the detected input (e.g., whether the position of the input indicates selection of a tool, an object rendered on the canvas, or region of the canvas), the frequency of the detected input in a given time period (e.g., double-click), and/or the start and end position of an input or series of inputs (e.g., start and end position of a click and drag), as well as various other input types which the user can specify (e.g., right-click, screen-tap, etc.) through one or more input devices.

In some examples, the rendering engine 120 and/or other components utilize graphics processing unit (GPU) accelerated logic, such as provided through WebGL (Web Graphics Library) programs which execute Graphics Library Shader Language (GLSL) programs that execute on GPUs. In variations, the web-based application 80 can be implemented as a dedicated web-based application that is optimized for providing functionality as described with various examples. Further, the web-based application 80 can vary based on the type of user device, including the operating system used by the user device 10 and/or the form factor of the user device (e.g., desktop computer, tablet, mobile device, etc.).

In examples, the rendering engine 120 uses the graphic design data set 157 to generate a rendering of a graphic design rendering 135 for the design interface 130, where the rendering(s) of the graphic design 135 includes graphic elements, attributes and attribute values. Each attribute of a graphic element can include an attribute type and an attribute value. For an object, the types of attributes include, shape, dimension (or size), layer, type, color, line thickness, text size, text color, font, and/or other visual characteristics. Depending on implementation, the attributes reflect properties of two- or three-dimensional designs. In this way, attribute values of individual objects can define, for example, visual characteristics of size, color, positioning, layering, and content, for elements that are rendered as part of the design.

The graphic design 135 can organize the graphic design by screens (e.g., representing production environment computer screen), pages (e.g., where each page includes a canvas on which a corresponding graphic design is rendered) and sections (e.g., where each screen includes multiple pages or screens). The user can interact, via the design interface 130, with the rendering(s) of the graphic design to view and edit the graphic design. The design interface 130 can detect the user input, and the rendering engine 120 can update the graphic design 135 in response to the input. For example, the user can specify input to change a view of the graphic design 135 (e.g., zoom in or out of a graphic design), and in response, the rendering engine 120 updates the graphic design 135 to reflect the change in view. The user can also edit the graphic design. The design interface 130 can detect the input, and the rendering engine 120 can update the graphic design data set 157 representing the updated design. Additionally, the rendering engine 120 can update the graphic design 135 of the graphic design, such that the user instantly sees the change to the graphic design 135 resulting from the user's interaction.

### Collaborative Environment

In examples, the GDIS 100 can be implemented as part of a collaborative platform, where a graphic design can be viewed and edited by multiple users operating different computing devices at locations. As part of a collaborative platform, when the user edits the graphic design, the changes made by the user are implemented in real-time to instances of the graphic design on the computer devices of other collaborating users. Likewise, when other collaborators make changes to the graphic design, the changes are reflected in real-time with the graphic design data set 157. The rendering engine 120 can update the graphic design 135 in real-time to reflect changes to the graphic design by the collaborators.

In implementation, when the rendering engine 120 implements a change to the graphic design data set 157, corresponding change data 111 representing the change can be transmitted to the network system 150. The network system 150 can implement one or more synchronization processes (represented by synchronization component 152) maintain a network-side representation of the graphic design. In response to receiving the change data 111 from the user device 10, the network system 150 updates the network-side representation of the graphic design and transmits the change data 111 to user devices of other collaborators. Likewise, if another collaborator makes a change to the instance of the graphic design on their respective device, corresponding change data 111 can be communicated from the collaborator device to the network system 150. The synchronization component 152 updates the network-side representation of the graphic design and transmits corresponding change data 111 to the user device 10 to update the graphic design data set 157. The rendering engine 120 then updates the graphic design 135 of the graphic design.

### Code Generation

In examples, the GDIS 100 includes processes represented by code generation 140 to generate code data for a code representation 145 of the graphic design. The code generation component 140 can include processes to access graphic design data set 157 of the workspace file 155 and to generate code data that represent elements of the graphic design. The generated code data can include production environment executable instructions (e.g., JavaScript, Python, Ruby, etc.) and/or information describing the layout or style of the graphic design (e.g., HTML, CSS, etc.).

In some examples, the graphic design data set 157 is structured to define multiple layers, where each layer corresponds to one of an object, a group of objects or a specific type of object. In specific examples, the types of layers can include a frame object, a group of objects, a component (i.e., an object comprised of multiple objects that reflect a state or other variation between the instances), a text object, in image, configuration logic that implements a layout or positional link between multiple objects, and other predefined types of elements. For each layer of the graphic design, the code generation component 140 generates a set of code data that is associated or otherwise linked to the design element. For example, each layer of the graphic design data set 157 can include an identifier, and the code generation component 140 can, for each layer, generate a set of code data that is associated with the identifier of the layer. The code generation component 140 can generate the code representation 145 such that elements of the code representation 145 (e.g., layout information, set of executable instructions, etc.) are associated with a particular layer of the graphic design 135. The associations can map individual code elements of the code representation 145 to corresponding design elements (or layers) of the graphic design 135 (as represented by the graphic design data set 157).

In some examples, the code interface 132 renders an organized presentation of code representation 145. For example, the code interface 132 can segment a presentation area into separate areas, including separate segments where production-environment executable code instructions are displayed (e.g., separate areas for HTML and CSS code). Further, the code interface 132 can include a separate segment to identify assets used in the graphic design, such as design elements that are part of a library associated with a library of an account associated with the user.

The code interface 132 can implement a combination of local, browser-based resources and/or network resources (e.g., application framework) provided through the programmatic interface 102 to generate a set of interactive features and tools for displaying code representation 145. In examples, the code interface 132 can enable elements of the code representation 145 to be individually selectable as input. For example, the user may select, as input, one or more of the following (i) a line of code, (ii) a portion of a line of code corresponding to an attribute, or (iii) portion of a line of code reflecting an attribute value. Still further, the user can select program code data displayed in different areas, program code of different types (e.g., HTML or CSS), assets, and other programmatic data elements.

### Plugin System

In the context of embodiments described, a plugin can correspond to a program that can execute on the end user device 10 to provide additional or enhanced functionality to the GDIS 100. A designer, for example, can execute a plugin in connection with utilizing the GDIS 100 to create or update a design. In addition, a developer can execute a plugin to generate the code representation 145 of one or more elements of the graphic design.

In examples, the plugin store 165 includes program files (e.g., executable files) which can execute at the selection of an end user in connection with the end user utilizing the GDIS 100 to create and/or update a design on a canvas. The plugins can be created by developers, including third parties to an operator of the GDIS 100. In examples, each plugin can be executable at the option of a user to implement a process separate from the functionality of the GDIS 100. Accordingly, the plugins stored with the plugin store 165 can provide additional or enhanced functionality for use with GDIS 100. This functionality can include developer mode plugins that the code generation component 140 can utilize to generate the code representation 145.

In examples, a developer can interact with the plugin system 160 to store a plugin file (or set of files that are used at time of execution) with the plugin store 165. The plugin files can include one or more executable files for the plugin, as well as for plugin execution logic. The plugin execution logic can include code, programs, programmatic processes and/or data which are accessed by the plugin system 160. In some implementations, the plugin execution logic includes metadata specified by the developer, where the metadata includes parametric values that correlates to plugin inputs that a user can provide in connection with execution of the plugin.

### Code Generation Plugins for Developers

Through the use of a developer plugin 142, the code generation component 140 can generate the code representation 145 in accordance with one or more preferences of the user, such as a selection of a programming language or framework supported by that developer plugin 142. In some aspects, developers or third parties create developer plugins 142 and save them with the GDIS 100 in the plugin store 165. For example, a developer may access the network system 150 to search for and download a developer plugin 142 into the plugin store 165 that supports a programming language that matches the developer's production environment. Alternatively, a developer can use tools to create a developer plugin 142 compatible with the GDIS 100.

In one implementation, the developer code generation plugin includes a manifest field that enables a plugin to define custom preferences for the plugin. These preferences allow users of the plugin to customize the developer code generation output and are available to the plugin via an application programming interface (API). Developer code generation preferences allow developers to define custom commands for the plugin that show up in the native dropdown settings interface for developer code generation. For example, one of these preferences includes a list of the programming languages supported for developer code generation in the native language selector dropdown in a developer mode for the GDIS 100. In these commands, plugin code can be executed, including the ability to open an iFrame on the code interface 132.

Accordingly, when using the developer plugin 142, a user can select one of the supported programming languages from the list included with the developer plugin 142. Developer code generation preferences can also include links to external repositories 143. To correctly implement the graphic design in a production environment, the developer plugin 142 can integrate with the external repositories 143 to pull in relevant information required to implement the design. For example, the developer plugin 142 may access a remote git repository to retrieve code that the code generation component 140 uses to augment the code representation 145.

In some examples, developer plugins 142 are read-only, meaning they can use plugin APIs that read from the design workspace file 155, they can respond to API events (e.g., change data 111 received from the network system 150), make network requests, or open iFrames to create or alter user interfaces; however, they are not able to edit the contents of the file 155. This is because developers often do not have edit access to the workspace file 155. Accordingly, the developer plugin 142 can access the workspace file 155, listen to events, and make network requests, but it cannot modify the workspace file 155 in any way. So, any method or operation that creates new nodes, deletes existing nodes, or modifies an existing node is not allowed.

In some aspects, the developer plugin 142 can call node.isAsset, which is an API that returns whether a given node is an asset. As used herein, an asset is a design element that is either an icon or a raster image. The GDIS 100 uses a set of refined heuristics to determine this, but in general, an icon is a small vector graphic and an image is a node with an image fill. The node.isAsset function returns true if the node is determined to be an asset and false otherwise. The node.isAsset function can be used to either show nodes that can be exported by a developer or used when generating code to put in an image URL or Scalable Vector Graphics (SVG) instead of application code. Accordingly, the developer plugin 142 can cause the code interface 132 to identify whether a node is an asset or not as part of the code representation 145.

In some aspects, the developer plugin 142 can infer a layout rule amongst one or more layers of the graphic design. The developer plugin 142 can define node.inferredAutoLayout, which is a property that determines the auto layout properties for a FrameNode, even if the frame is not configured with an auto layout feature. The node.inferredAutoLayout property returns an object with a subset of the auto layout properties that normally exist on a Frame node if the GDIS 100 is able to infer auto layout. The auto layout properties can include a spatial relationship amongst multiple layers of the graphic design. If the GDIS 100 is not able to infer auto layout, null is returned. In some aspects, the developer plugin 142 can define node.getCSSAsync, which returns an object that resolves to key/value pairs of CSS properties. The key/value pairs of CSS properties may then be used by the developer plugin 142 as part of a conversion process to another programming language. For example, a developer plugin 142 for the styled-components React library could leverage the CSS key/value pairs to speed up development.

In some aspects, the developer plugin 142 can define a getSelectionColors function, which returns the colors in a user's current selection. This returns the same values that are shown in a native selection colors feature. This can be useful for getting a list of colors and styles in the current selection and converting them into a different code format (like CSS variables for a user's codebase).

In some examples of the developer mode of the GDIS 100, only one object can be selected at a time to simplify navigation and inspection. A developer mode panel, such as provided with the code interface 132, can include a simplified view of properties, code, and assets. If a plugin for Dev Mode has an iFrame, the iFrame may be docked in a new tab by default. This ensures the plugin's iFrame does not obscure parts of the design interface 130 or what developers need to implement.

### Code Editor Extension

In addition or in an alternative to enhancing functionality within the GDIS 100 itself, the plugin system 160 can operate within an extension of a third-party code editor, such as Visual Studio Code. Such an extension can enable the third-party code editor to display the design interface 130 and/or the code interface 132 within the code editor, thereby allowing a user to interact with the workspace files 155 and code representation 145 from within the code editor.

In some aspects, the code editor extension provides auto-complete suggestions to a user based on a selected layer of the graphic design 135 within the code editor. These auto-complete suggestions may be generated through one of the developer plugins 142. For example, a user may select one of the developer plugins 142 through a plugins list within the extension, and then when the auto-complete feature activates, it can generate suggestions using the selected developer plugin 142 instead of or in addition to the default sources of suggestions.

### Plugin Preview

In some aspects, the plugin system 160 supports a preview function which triggers the execution of specific plugins when a developer or designer adds a relevant link to a design resource, such as the workspace file 155. This functionality allows for the generation of rich previews associated with the linked content. For example, upon a user inserting a link corresponding to a supported plugin, such as a GitHub, JIRA, or Linear plugin, the GDIS 100 recognizes the link (e.g., URL) and runs the appropriate plugin in the background. The processes performed by the GDIS 100 in recognizing the link can include searching a plugin store for a plugin identifier that is a match to the link. Further, the processes performed by the GDIS 100 in recognizing an inserted link and running the appropriate plugin can be automatic. The plugin fetches detailed information and generates a preview that is displayed in a side panel within the design interface 130.

The preview generation process can include authenticating the user, if necessary, to access more detailed information related to the link. The plugin's output, such as task details from a project management tool (e.g., from one or more external repositories 143), can be saved as part of the workspace file 155. For example, the plugin output may be saved as a JSON text representation or any other context-appropriate format. This ensures that when the workspace file 155 is shared with other collaborators, upon one of the collaborators opening the workspace file 155, the GDIS 100 can display the pre-generated preview without needing to re-run the plugin or go through additional authentication steps.

The design environment efficiently handles plugin executions triggered by link insertions, aiming to improve work efficiency. Instead of requiring users to manually select and run plugins, the plugin system 160 automates this process, enhancing productivity and ensuring consistency across shared workspace files 155. By leveraging OAuth flows, the plugins can retrieve comprehensive data, enabling richer and more useful previews. This integration framework can be extended to support various types of links and plugins, providing a versatile solution for embedding interactive and informative elements within design resources.

### Selecting Code to View Design Elements

The code interface 132 can detect user input to select a code element. In response to detecting user input to a specific code element, the code interface 132 can identify the associated design element(s) (or layer) associated with that code element to the design interface 130. For example, the code interface 132 can identify a particular layer that is indicated by the selection input of the user. The code interface 132 can indicate the identified layers or design elements to the design interface 130, to cause the design interface 130 to highlight or display in prominence the design element(s) that are associated with the selected code elements. In some examples, the design interface 130 can visually indicate design element(s) associated with code elements that are selected through the code interface 132 in isolation, or separate from other design elements of the graphic design. In such case, other design elements of the graphic design can be hidden, while the associated design element is displayed in a window of the design interface 130. In this way, when the user interacts with the code interface 132, the user can readily distinguish the associated design element from other design elements of the graphic design.

### Selecting Code to View Design Elements

Within developer mode, a developer plugin 142 calls a generate function to register a callback that is called when the selection of a layer on the graphic design is changed by the user. This callback returns the internal representation of the selected layer. In one example, the internal representation is an array of JavaScript objects that represent the sections in the inspect panel. The JavaScript objects can each include code, language, and title properties. The callback can also return an object representing the current state of the operation in the event that the function is asynchronous and needs to perform data fetching or other asynchronous operations to generate the code for the selected layer.

In some aspects, the developer plugin 142 converts the internal representation to the programming language selected by the user. For example, the JavaScript objects may be parsed and used to generate equivalent HTML and CSS to render the graphic design in a production environment. The HTML and CSS generated is displayed on the code interface 132, where the user can copy and paste the lines of code (and any extra data retrieved and processed from the external repositories 143) into a separate development environment to implement the graphic design in the production environment.

### Selecting Code to Navigate to Design Element

Further, the selection of a code element in the code interface 132 can cause the design interface 130 to navigate to the particular set of design elements that are identified by the selected code element. For example, the code element 132 can identify the layer that is selected by the user input, and the design interface 130 can navigate a view of the graphic design 135 to a canvas location where the associated design element is provided. As an addition or variation, the design interface 130 can navigate by changing magnification level of the view, to focus in on specific design elements that are associated with the identified design element.

### Synchronizing Design and Code Interface

In examples, the design interface and the code interface 132 can be synchronized with respect to the content that is displayed through each interface. For example, the code interface 132 can be provided as a window that is displayed alongside or with a window of the design interface. In an aspect, the code interface 132 displays code elements that form a portion of the code representation, where each code element is associated with a layer or design element having a corresponding identifier. In turn, the design interface 130 uses the identifiers of the layers/design elements to render the design elements of the graphic design 135 that coincide with the code elements displayed by the code interface 132.

Further, the GDIS 100 can implement processes to keep the content of the design interface 130 linked with the content of the code interface 132. For example, if the user scrolls the code data displayed through the code interface 132, the design interface 130 can navigate or center the rendering of the graphic design 135 to reflect the code elements that are in view with the code interface 132. As described, the design interface 130 and the code interface 132 can utilize a common set of identifiers for the layers or design elements, as provided by the graphic design data set 157.

### Modifying Graphic Design Through Code Interface

In examples, a user of device 10 can modify the graphic design 135 by changing the code representation using the code interface 145. For example, a user can select a code element displayed through the code interface 132, and then change an attribute, attribute value or other aspect of the code element. The input can identify and change the layer or design element as defined in a structure defined by the graphic design data set 157. In response, the rendering engine 120 can update the rendering of the graphic design 135, to reflect the change made through the code interface 132. In this way, a developer can make real-time changes to, for example, a design interface to add, remove or otherwise modify (e.g., by change to attribute or attribute value) a layer or design element.

### Viewing and Modifying Code Elements Through Design Interface

Additionally, in examples, a user can select design elements of the graphic design through interaction with the design interface 130. For example, a user can select or modify a layer of the graphic design. The design interface 130 can identify the layer for the code interface 132. In response, the code interface 132 can highlight or otherwise visually distinguish code elements (e.g., lines of code) that are associated with the identified design element from a remainder of the code representation 145. In this way, a developer can readily inspect the code elements generated for a design element of interest by selecting a design element, or a layer that corresponds to the design element in the design interface 130, and viewing the code generated for the selected element or layer in the code interface 132.

Further, in examples, the user can edit the graphic design 135 through interaction with the design interface 130. The rendering engine 120 can respond to the input by updating the graphic design 135 and the graphic design data set 157. When the graphic design data set 157 is updated, the code generation component 140 can update the code representation 145 to reflect the change. Further, the code interface 132 can highlight, display in prominence or otherwise visually indicate code elements that are changed as a result of changes made to the graphic design 135 via the design interface 130.

### Code Generation to Reflect Changes to Design Interface

In additional examples, a change detection component can determine a change in the graphic design 135, and the changes in the graphic design can be indicated in the graphic design data set 157 and the code representation 145. For example, in a collaborative environment, the graphic design data set 157 can change between sessions of a user of the device 10 as a result of work done by other collaborators. In examples, the design interface 130 can indicate design elements of the graphic design that changed from a previous point in time (e.g., such as between user sessions).

In examples, the code generation component 140 can generate code to update the code representation 145 based on the change data set. The code interface 132 can indicate code elements of the graphic design that are new or modified from the prior user's session. In this way, a designer can view what has changed between graphic designs. Likewise, a developer can view corresponding changes to the code representation 145, which may be the result of changes made by a designer of the graphic design.

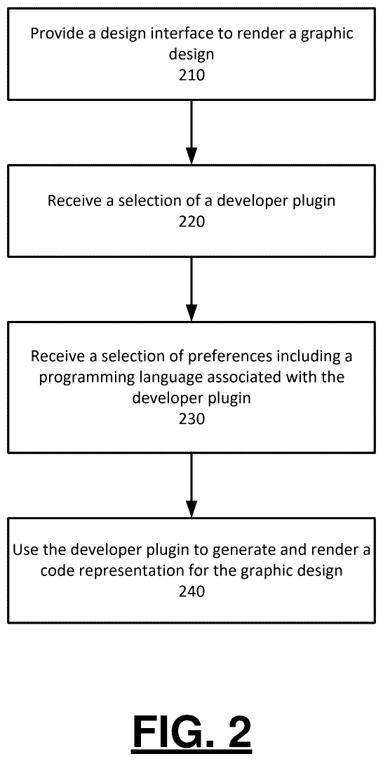

FIG. 2 illustrates a method of using a graphic design code generation plugin system, according to one or more examples. Some of the steps of this method may be performed in parallel or in a different order than illustrated.

In one example, a computer system, such as the GDIS 100 of FIG. 1, provides a design interface to render a graphic design (210). The graphic design can be represented through one or more workspace files 155 and rendered by a rendering engine 120 on the design interface 130 of the GDIS 100.

The computer system can receive a selection, from a user, of a developer plugin (220). This selection can be made on the program interface 102 of the GDIS 100.

The computer system can receive a selection of preferences including a programming language associated with the developer plugin (230). The computer system can use the developer plugin to generate and render a code representation 145 on the code interface 132 for the graphic design (240).

### Examples

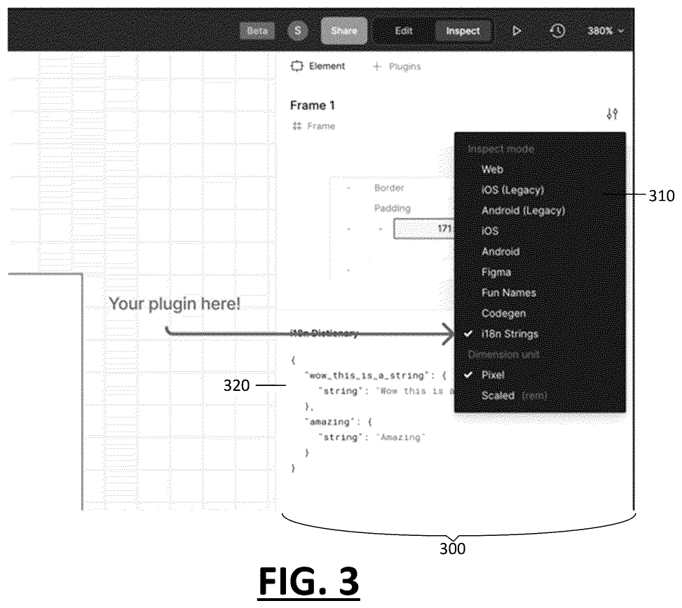

FIG. 3 illustrates an example developer mode plugin interface. Developer code generation plugins can extend and/or replace the built-in code generation that exists in an inspect panel 300. As shown, the iOS and Android code generation options in the inspect mode menu 310 are built-in options labelled as (Legacy), and the other options are provided by developer code generation plugins used to generate code for languages and frameworks that the graphic design system does not support natively. In this example, the selected language in the inspect mode menu 310 is “i18n Strings,” which is an internationalization framework written in and for JavaScript. Accordingly, when a user selects an object, the code generation component uses the developer plugin “i18n Strings” to generate i18next strings to be displayed on the code interface 320.

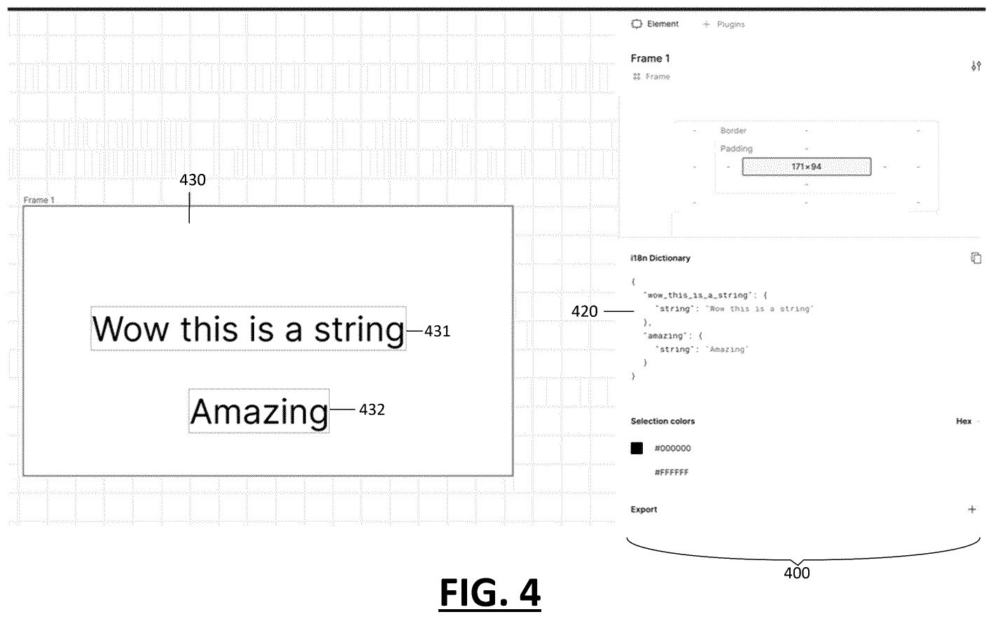

FIG. 4 illustrates an example use of a developer plugin generating a portion of a graphic design. Continuing from the example of FIG. 3, the user has selected the Frame 1 object 430, which includes a pair of strings. Often, developers need to pull out strings for an internationalization dictionary when doing application development. Thus, the “i18n Strings” plugin example retrieves the text nodes 431, 432 under the current selection and builds a JSON dictionary of them, which can be seen displayed on the code interface 420 of the inspect panel 400 on the right side.

### Network Computer System

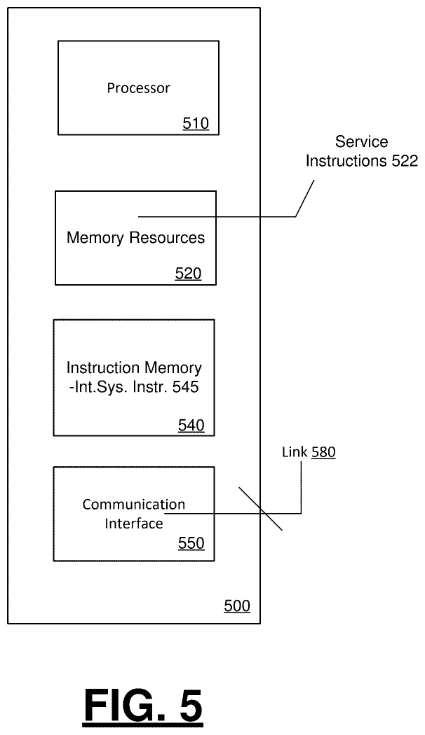

FIG. 5 illustrates a computer system on which one or more embodiments can be implemented. A computer system 500 can be implemented on, for example, a server or combination of servers. For example, the computer system 500 may be implemented as the network computing system 150 of FIG. 1.

In one implementation, the computer system 500 includes processing resources 510, memory resources 520 (e.g., read-only memory (ROM) or random-access memory (RAM)), one or more instruction memory resources 540, and a communication interface 550. The computer system 500 includes at least one processor 510 for processing information stored with the memory resources 520, such as provided by a random-access memory (RAM) or other dynamic storage device, for storing information and instructions which are executable by the processor 510. The memory resources 520 may also be used to store temporary variables or other intermediate information during execution of instructions to be executed by the processor 510.

The communication interface 550 enables the computer system 500 to communicate with one or more user computing devices, over one or more networks (e.g., cellular network) through use of the network link 580 (wireless or a wire). Using the network link 580, the computer system 500 can communicate with one or more computing devices, specialized devices and modules, and/or one or more servers.

In examples, the processor 510 may execute service instructions 522, stored with the memory resources 520, in order to enable the network computing system to implement the network service 172 and operate as the network computing system 170 in examples such as described with FIG. 1A through FIG. 1C.

The computer system 500 may also include additional memory resources (“instruction memory 540”) for storing executable instruction sets (“Int. sys. instr. 545”) which are embedded with webpages and other web resources, to enable user computing devices to implement functionality such as described with the GDIS 100.

As such, examples described herein are related to the use of the computer system 500 for implementing the techniques described herein. According to an aspect, techniques are performed by the computer system 500 in response to the processor 510 executing one or more sequences of one or more instructions contained in the memory 520. Such instructions may be read into the memory 520 from another machine-readable medium. Execution of the sequences of instructions contained in the memory 520 causes the processor 510 to perform the process steps described herein. In alternative implementations, hard-wired circuitry may be used in place of or in combination with software instructions to implement examples described herein. Thus, the examples described are not limited to any specific combination of hardware circuitry and software.

### User Computing Device

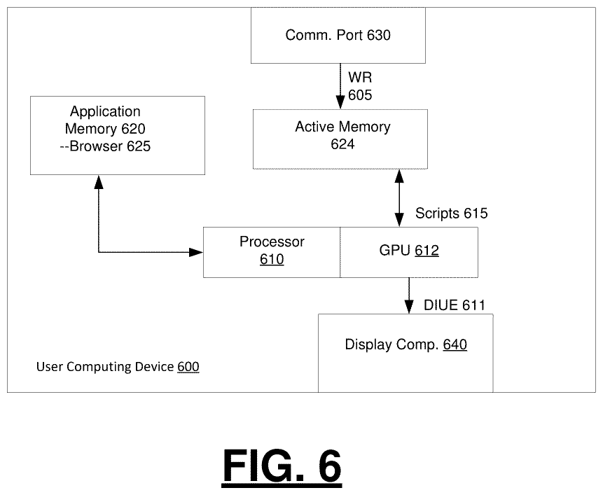

FIG. 6 illustrates a user computing device for use with one or more examples, as described. In examples, a user computing device 600 can correspond to, for example, a work station, a desktop computer, a laptop or other computer system having graphics processing capabilities that are suitable for enabling renderings of design interfaces and graphic design work. In variations, the user computing device 600 can correspond to a mobile computing device, such as a smartphone, tablet computer, laptop computer, VR or AR headset device, and the like.

In examples, the computing device 600 includes a central or main processor 610, a graphics processing unit 612, memory resources 620, and one or more communication ports 630. The computing device 600 can use the main processor 610 and the memory resources 620 to store and launch a browser 625 or other web-based application. A user can operate the browser 625 to access a network system 150, using the communication port 630, where one or more web pages or other resources 605 associated with the network system 150 can be downloaded. The web resources 605 can be stored in the active memory 624 (cache).

As described by various examples, the processor 610 can detect and execute scripts and other logic which are embedded in the web resource in order to implement the GDIS 100 (see FIG. 1). In some of the examples, some of the scripts 615 which are embedded with the web resources 605 can include GPU accelerated logic that is executed directly by the GPU 612. The main processor 610 and the GPU can combine to render a design interface under edit (“DIUE 611”) on a display component 640. The rendered design interface can include web content from the browser 625, as well as design interface content and functional elements generated by scripts and other logic embedded with the web resource 605. By including scripts 615 that are directly executable on the GPU 612, the logic embedded with the web resource 615 can better execute the GDIS 100, as described with various examples.

### CONCLUSION

Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A computer system comprising:
a memory resource storing instructions; and
one or more processors using the instructions stored in the memory resource to perform operations including:
providing a design interface to render at last a portion of a graphic design; and
providing a code interface to render a code representation for at least a portion of the graphic design, wherein providing the code interface includes executing one or more plugins to generate the code representation, the one or more plugins including at least a first plugin that is selectable by a user to configure the generation of the code representation in accordance with one or more preferences.

2. The computer system of claim 1, wherein the first plugin supports a plurality of programming languages for the code representation.

3. The computer system of claim 2, wherein the one or more preferences include a selection of a first programming language from the plurality of programming languages.

4. The computer system of claim 3, wherein the first plugin converts an internal representation of at least some of the graphic design into the first programming language, the first program language being different from the internal representation.

5. The computer system of claim 1, wherein the first plugin retrieves data from one or more external repositories and integrates the data into the code representation.

6. The computer system of claim 1, wherein the graphic design is structured to define a plurality of layers, wherein each layer of the plurality of layers corresponds to one of an object, a group of objects, or a type of object; and
wherein executing the one or more plugins is performed in response to the user selecting a layer of the plurality of layers using one of the design interface or the code interface.

7. The computer system of claim 1, wherein executing the one or more plugins includes causing the code interface to identify an asset as part of the code representation.

8. The computer system of claim 4, wherein executing the one or more plugins includes inferring a layout rule amongst one or more layers of the graphic design.

9. The computer system of claim 8, wherein the layout rule specifies a spatial relationship amongst multiple layers of the graphic design.

10. The computer system of claim 8, wherein the layout rule specifies a spacing between multiple layers of the graphic design.

11. The computer system of claim 1, wherein the first plugin is a third-party plugin.

12. The computer system of claim 1, wherein the first plugin has read-only access to the graphic design.

13. A method being implemented by one or more processors and comprising:
providing a design interface to render at last a portion of a graphic design; and
providing a code interface to render a code representation for at least a portion of the graphic design, wherein providing the code interface includes executing one or more plugins to generate the code representation, the one or more plugins including at least a first plugin that is selectable by a user to configure the generation of the code representation in accordance with one or more preferences.

14. The method of claim 13, wherein the first plugin supports a plurality of programming languages for the code representation.

15. The method of claim 14, wherein the one or more preferences include a selection of a first programming language from the plurality of programming languages.

16. The method of claim 15, wherein the first plugin converts an internal representation of at least some of the graphic design into the first programming language, the first program language being different from the internal representation.

17. The method of claim 13, wherein the first plugin retrieves data from one or more external repositories and integrates the data into the code representation.

18. The method of claim 13, wherein the graphic design is structured to define a plurality of layers, wherein each layer of the plurality of layers corresponds to one of an object, a group of objects, or a type of object; and
wherein executing the one or more plugins is performed in response to the user selecting a layer of the plurality of layers using one of the design interface or the code interface.

19. The method of claim 13, wherein executing the one or more plugins includes causing the code interface to identify an asset as part of the code representation.

20. A non-transitory computer-readable medium that stores instructions, executable by one or more processors, to cause the one or more processors to perform operations including:
providing a design interface to render at last a portion of a graphic design; and
providing a code interface to render a code representation for at least a portion of the graphic design, wherein providing the code interface includes executing one or more plugins to generate the code representation, the one or more plugins including at least a first plugin that is selectable by a user to configure the generation of the code representation in accordance with one or more preferences.
